(19) United States
(12) Patent Application Publication
(10) Pub. No.: US 2007/0040382 A1
(43) Pub. Date: Feb. 22, 2007

(54) Self-supporting power generation station

(76) Inventor: Timothy D. Towada, Elmhurst, IL (US)

Correspondence Address: DYKEMA GOSSETT PLLC, 10 S. WACKER DR., STE. 2300, CHICAGO, IL, 60606, US

(21) Appl. No.: 11/290,133

(22) Filed: Nov. 30, 2005

Related U.S. Application Data
(60) Provisional application No. 60/631,838, filed on Nov. 30, 2004.

(51) Int. Cl. H02K 7/18

(52) U.S. Cl. 290/1 A

(57) ABSTRACT

A scalable micro-grid for providing power to areas remote from the existing power grid. At least two power pods linked in parallel. Each power pod has at least one, micro-turbine fueled by methane gas. As power needs increase, additional power pods are added to the system to meet the additional power needs. The power pods have redundancy such as a diesel genset to ensure continuous power. Power pods are more environmentally friendly than diesel generators and independent of existing power grid. Installation of a power pods requires a short lead-time and thus can be put into operation as soon as the need for more power arises. The power generation source is close to the power consumption point. Removal cost is minimal and the equipment can be reused in another remote power generation locale.

The present invention claims the benefit of U.S. Provisional Application No. 60/631,838 filed 30 Nov. 2004.

### BACKGROUND OF THE INVENTION

1. Field of the Invention

The present invention relates to power generation. More particularly, it relates to a scalable self-supporting power generation stations utilizing divergent, but complimentary technologies—reciprocating engine-generators with bi-fumigation and micro-turbines—for use in locations remote from the existing power grid.

2. Description of Related Art

It is, in some instances, necessary to have a power supply in a location remote from the existing electric power grid. For example, mining or drilling operations often occur in locations remote from the existing power grid. However, these activities still require a reliable, continuous source of power. There is a need for a dependable, continuous power source to maintain operations in remote locations. The proper allocation of the respective power generation technologies is determined by the Supervisory Control and Data Acquisition (SCADA) tracking the dynamic loads.

For example, there are methane gas reserves in the western United States. The depth of the gas varies throughout the reserve. Where the gas in located closer to the surface, such as within 200 feet of the surface, small 5-10 horse power motors are sufficient to run the pumps. In other areas the gas is located deeper in the earth—in some cases over 1500 feet below the surface. Pumps with 10-50 horsepower motors are needed to pump the gas in these areas. The wells are often located in areas remote from the existing power grid. Thus, there is a need for a method to provide reliable, continuous power to the wells in a cost effective manner. Further, there is a need for a power supply that is readily expandable to allow for expansion of the number of wells.

For example, the largest US gas exploration and production is located in remote northeast Wyoming and southeast Montana. There is expected to be 43,000 new wells over the next 13 years. Gas companies have traditionally utilized a central coal power generation plant with an electric grid eventually built out to the remote well sites. The electricity is required to power pumps that remove water from the wells and to compress the gas. Some gas companies also use portable diesel engine-generators as a means of power until the electric grid reaches the new well.

In the past, power was supplied to the wells, either by expanding the existing power grid or by using diesel generators. Expanding the existing grid involves running high voltage lines to the well field. This solution is very costly to the gas company, as the power company requires the user pay for the installation/expansion of the grid and for its removal at the end of the project in addition to paying for the electricity, transmission charges and other fees. There is a need for a system that is economical and independent of the existing power grid.

A significant problem with expanding the existing power grid is the long lead-time needed for expansion. There is a need for a scalable solution where the expansion can occur in a time efficient manner so that companies can produce gas faster. There is a need for a system that allows for expansion on in a relatively short time frame such as a similar time frame as is required develop a new well.

The overhead towers and high voltage wires are obtrusive, unsightly and not environmentally friendly. The impact of overhead towers and high voltage wires is not insignificant. Gas companies have been stalled by lawsuits arising out of landowner complaints about the power lines and towers. Thus, there is a need for unobtrusive power generation that minimizes any negative effect on the environment. There is a need for a system that is better for the environment that expanding the existing grid.

A second prior art solution is to use diesel generators. However, there are environmental impact issues that arise when using diesel generators. There is a need for a system with minimal environmental impact. Further, using diesel generators is expensive.

### SUMMARY OF THE INVENTION

The present invention is a scalable micro-grid for providing power to areas remote from the existing power grid. The inventive power system was developed to power a gas pumping operation. However due to its scalability, the inventive system is not limited to pumping operations and can be used to power any remote system such as drilling and mining.

The inventive system comprised at least two power pods linked in parallel. Each power pod comprises at least one, preferably two, micro-turbines fueled by methane gas. As the power needs increase, additional power pods can be added to the system to meet the additional power needs. The power pods preferably have redundancy such as a diesel genset to ensure continuous power. A genset is a combustion engine driving an electrical generator. Not only are the inventive power pods are more environmentally friendly than diesel generators, the inventive power pods are completely independent of existing power grid. The inventive system is better for the environment. It is clean burning and there are no overhead towers or high voltage wires.

The inventive power pods have a short lead-time and thus can be put into operation as soon as the need for more power arises. The power generation source is close to the power consumption point. Any removal cost is minimal and the equipment can be reused in another remote power generation locale.

### BRIEF DESCRIPTION OF THE FIGURES

FIG. 1 is a block diagram of a power station.

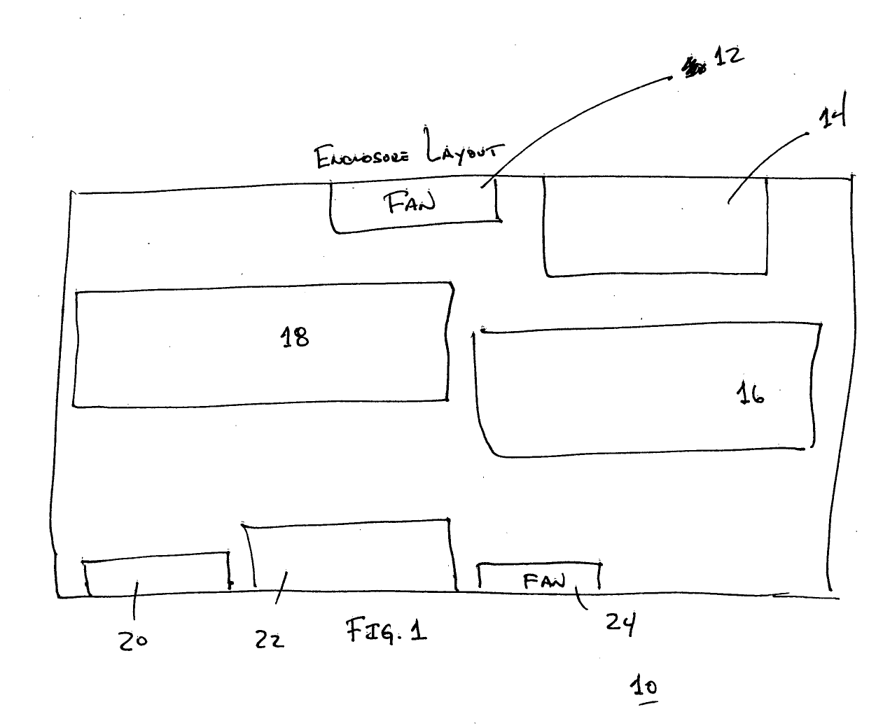

FIG. 2 is a single line diagram of a power station.

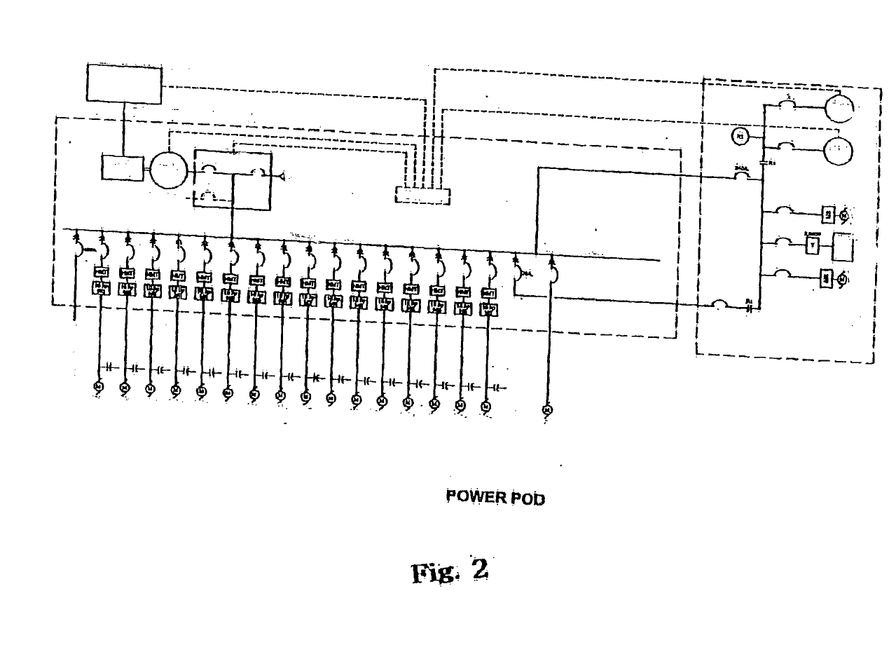

FIGS. 3a-c are a front elevation, rear elevation and a cross sectional view of a generator for a power station.

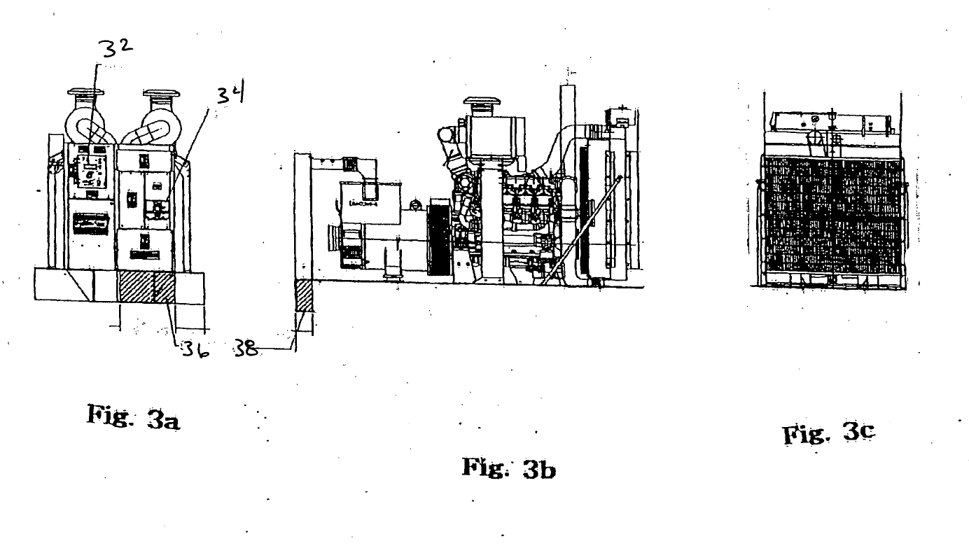

### DETAILED DESCRIPTION OF THE INVENTION

There are methane gas reserves in the western United States. The depth of the gas varies throughout the reserve. Where the gas in located closer to the surface, such as within 200 feet of the surface, small 5-10 horse power motors are sufficient to run the pumps. In other areas the gas is located deeper in the earth—in some cases over 1500 feet below the surface. Pumps with 10-50 horsepower motors are needed to pump the gas in these areas. The deep wells are located in an area remote from the existing power grid. The inventive power pod supplies reliable, continuous power to wells in a cost effective manner. Further, there inventive power supply is readily expandable to allow for expansion of the number of wells.

The largest US gas exploration and production is located in remote northwest Wyoming and southeast Montana. 43,000 new wells are expected in the next 13 years. The inventive power pod is a system to supply power to these remote wells in a scalable, cost effective, prompt and green manner.

Methane gas wells run 24 hours a day, 7 days a week, 52 weeks a year. Therefore it is important that the power source have at least one built in redundancy. In addition, it is preferable, that gross power generated exceeds the peak demand. In a well field having 32 wells, where on average each well has a 10-horsepower motor, two inventive power pods are connected in series. Preferably, each power pod services 16 wells. The power pods are preferably located at a central location.

The power pods each comprise a reciprocating Engine-Generators fueled by combination of coal bed methane (CBM) gas and diesel fuel and at least one micro turbine. The reciprocating engine generator supports dynamic loading and redundancy. Depending on load dynamics (as monitored by SCADA) the reciprocating engine-generator may be in one of three states:
Not running or steady state load;
Running in parallel with the Micro Turbine at a ratio determined by the load/SCADA; or
Supporting the entire load dynamic load such as when the micro turbines are not running.
   The power pod preferably has two or four micro turbines fueled by CBM. The micro turbines are preferably connected in parallel. The micro turbines support base-loading steady state load conditions. Depending on load dynamics (as monitored by SCADA) the micro turbines may be in one of three states:
Not running or dynamic load;
Running in parallel with the reciprocating engine-generator at a ratio determined by the load/SCADA; or
Supporting the entire load in a steady state base load when the reciprocating engine-generator is not running.

The inventive power pod comprises at least one enclosure. The enclosure is preferably an all weather enclosure. Preferably, there are two enclosures. A first enclosure houses controls and distribution equipments and a second enclosure houses generator(s) and protects the generator(s) from the elements. Preferably, the generators are micro-turbines. Alternatively, bi-fuel reciprocating genset can be used in addition to the micro turbine. The preferred enclosure is transportable. The preferred enclosure is 8 feet wide, 8.5 feet high and 20 feet long. Preferably, the enclosure has access doors on both ends. The enclosure can operate alone or in combination with a second enclosure with the controls. Most preferably, the power pod comprises two enclosures. The most preferable enclosure is an 8-foot by 20-foot Iso Containers to house the micro turbines.

The preferred power pod is pre-assembled and can be quickly transported to the desired location and set up. The pre-assemble power pod includes an enclosure with two micro-turbine gensets, control system, power electronics, lubricating oil systems, engine alternator assembly, recuperator, gas boost compressor, ventilation for the enclosure, and power panel. A distribution panel can be added to provide power distribution feed.

Each container/enclosure preferably houses two micro-turbines. Preferably the micro turbines are rated 80 kW each with gas compressor. Each power pod preferably also comprises a 300 kW reciprocating generator with weatherproof enclosure mounted on skid with SCADA equipment (such as Virtual Power Plant™ by Encorp) with weatherproof enclosure mounted on same skid as the reciprocating generator. The reciprocating generator preferably is with bi-fumigation system.

The power pod preferably also includes hardware and software to access each power pod via telephone or computer network for remote control, start, stop, configuration management, and troubleshooting.

Preferably, the generators are fueled by unprocessed methane gas. Alternative fuel sources could be used. However, unprocessed coal bed methane gas is accessible at the generation site. The methane gas should be supplied at sufficient pressure to facilitate the reciprocating genset. The generators preferably, generate power at 480V. It is preferable, that the gross power generated by the power pods exceeds the peak demand. For example, if a power pod services 16 wells with an average 10 hp motor, the gross power generated exceeds the peak demand by 73%. It is also preferable, that there is redundancy in the system since the pumps run continuously. In on embodiment, diesel generators or preferably bi-fuel reciprocating gensets are used as back up. In an alternative embodiment, if one power pod fails excess gross power of one or more operating power pod is used to supply pumps. In yet another embodiment, redundancies in the system include both at least one diesel generator or one bi-fuel reciprocating genset and the ability to use the excess power generated.

A typical well production area can be serviced by a power pod having four micro turbines, each producing 320 kW of continuous power to service approximately 20 wells. There is approximately one “drop” supporting every 3-4 wells or approximately 6-7 drops from each power pod to the wells.

Optionally, the power pods can include virtual control devices to increase the control and efficiency of the pumps. It is preferable that, the harmonics are kept within IEEEE519 limits by use of harmonic transformers. One virtual control that would be suitable for this application is Virtual Power Plant™. Virtual Power Plant™ monitors the load dynamics so the proper ratio of power generation resources (reciprocating generator to and micro turbines) is utilized. Virtual controls also provide for paralleling of power generation resources, diagnostics, monitoring, service alarm call out and future import/export of power to accommodate micro grids.

The linked power pods act as a micro-grid for servicing the well field. The micro-grid can be expanded by linking additional power pods to the system. Preferably, additional power pods are added by connecting adjoining sites via radial drops.

The power pod is preferably monitored via satellite. This is useful since the power pod is used in relatively remote locations. The micro-turbines, diesel bi-fuel reciprocating, fuel level, paralleling gear, SCADA and MCC are all monitored. Preferably, the controls include internal diagnostics and allow a user to make some repairs and run diagnostic testing via satellite or other communication network.

During the initial set up of a power pod for a methane gas well field, bi-fuel genset of the power pod runs on diesel fuel. As the pumps begin to supply unprocessed methane gas, the micro-turbines are energized. Initially, the well field's power requirements may be more dynamic that the micro-turbines can tolerate. In that case, the micro-turbine will supply the baseline power and the bi-fuel genset will provide additional power to power to motor at peak load times. After a time, the micro-turbines are able to supply in excess of the well fields power needs. At that point, the bi-fuel genset is a back-up power supply only. Additional back-up power can be provided to other power pods on the micro grid.

The inventive power pods are environmentally friendly. The micro-turbines run on methane gas and the bi-fuel genset run on 20% diesel and 80% natural gas and thus burn cleaner than a diesel genset.

Two power pods can be connected in series to form a micro-grid. Additional power pods can be added to the micro-grid via radial drops. Thus, the system is scalable.

The power pods use natural gas and thus are environmentally friendly. Furthermore, they can be moved to another location and used again.

The power pods can be started using the bi-fuel genset running on diesel fuel only, thus a power pod id completely independent of existing power grid.

Because the enclosure is fully assembled, the power pod can be operational with a very short lead-time. The transportable enclosure can be moved to a location, installed and be up and running with a very short lead-time. It can be linked to other power pods to form a micro-grid. When the power needs change additional power pods can be added or one, more or even all power pods can be removed. The transportable power pod could be moved to another location. The power pod is a more economical, cost effective, and timely solution than the prior art remote power generation. It is also a more environmentally friendly solution that the prior art solutions.

1. A power pod comprising
at least one reciprocating engine generator and
at least one micro turbine fueled,
wherein the engine-generator is in a not running state, a steady state load, running in parallel with the micro turbine, or supporting the entire load dynamic load.

2. The power pod of claim 1 wherein the engine generator is fueled by a combination of coal bed methane (CBM) gas and diesel fuel and the micro turbine is fueled by CBM.

3. The power pod of claim 1 further comprising at least two micro turbines connected.

4. The power pod of claim 2 further comprising at least two micro turbines connected in parallel.

5. The power pod of claim 4 wherein the micro turbines are in a not running state, a steady state load, running in parallel with the engine generator, or supporting the entire load dynamic load.

6. The power pod of claim 2 further comprising at least one enclosure.

7. The power pod of claim 6 wherein the enclosure is an all weather enclosure.

8. The power pod of claim 4 further comprising:
A control system,
power ditricution equipment
a first and a second enclosure
wherein the first enclosure houses controls and distribution equipment and the second enclosure houses the engine generator and the micro-turbines.

9. The power pod of claim 8 wherein each housing is transportable.

10. The power pod of claim 7 further comprising a bi-fuel reciprocating genset

11. The power pod of claim 7 further comprising:
power electronics,
a lubricating oil system,
an engine alternator assembly,
a recuperator, and
a gas boost compressor.

12. The power pod of claim 7 further comprising hardware and software to a\for remote access to each power pod via telephone or computer network for remote control, start, stop, configuration management, and troubleshooting.

13. The power pod of claim 3 further comprising a diesel generators or a bi-fuel reciprocating gensets.

14. The power pod of claim 3 wherein the power pod if connected to at least one additional power pod to form a microgrid.

15. The power pod of claim 3 wherein the power pod data is monitored via satellite, power pod data compromises one or more of micro-turbines status, diesel bi-fuel reciprocating gen-set status, fuel level, paralleling gear status, SCADA and MCC.
